(19) United States
(12) Patent Application Publication
(10) Pub. No.: US 2006/0115651 A1
(43) Pub. Date: Jun. 1, 2006

(54) Painted glass tiles, panels and the like and method for producing painted glass tiles and panels

(75) Inventors: Melissa S. Merfeld, Tampa, FL (US); Eddie F. Davis, Galax, VA (US)

Correspondence Address: NIXON & VANDERHYE, PC, 901 NORTH GLEBE ROAD, 11TH FLOOR, ARLINGTON, VA, 22203, US

(73) Assignee: GUARDIAN INDUSTRIES CORP., Auburn Hills, MI (US)

(21) Appl. No.: 10/999,150

(22) Filed: Nov. 30, 2004

(51) Int. Cl. B32B 9/00; B32B 17/06

(52) U.S. Cl. 428/410; 428/432; 428/408

(57) ABSTRACT

A process and apparatus for painting float glass in particular using a production line that may also be used as or is similar to a mirror line, to produce decorative glass panels. In an embodiment of the invention, painted glass tiles are cut from the glass panels after the paint has dried/cured using a typical glass panel cutter. As such, a mass production technique is provided for making painted glass tiles, particularly for residential use.

### BACKGROUND OF THE INVENTION

Glass is increasing in popularity for use on or as surfaces from counters to floors because it is impervious to water and relatively easy to clean.

Painted glass tiles are currently imported into the United States from a variety of countries, including Australia, England, Italy and the Czech Republic. Despite growing popularity of glass tile, domestic supplies are currently essentially non-existent other than tiles hand made by artisans. It would be desirable to manufacture domestically painted glass tiles for use as wall tile, counter tops, back splashes, accent tiles, and even residential flooring. Indeed, the mass production of painted glass tiles domestically would significantly reduce the manufacturing costs of the product so as to be highly cost competitive with the imported products currently available. Furthermore, there is a need for larger size glass tiles, for example 12×12 and up, since imported tiles are generally cast as opposed to flat glass and larger sizes are difficult to achieve and are inconsistent in appearance.

### SUMMARY OF THE INVENTION

The invention proposes to use a mirror line for producing painted glass sheets which may be cut to produce glass panels or individual glass tiles for floor, wall or counter applications. More specifically, the invention proposes to use the excess capacity on a mirror line to make glass tiles. Thus, in an embodiment of the invention, a conventional mirror line may be temporarily modified so that all the silver and chemicals associated with mirror production are cut off upstream, and to change out the paint so that rather than the mirror coat paint being applied, a glass paint is applied. To change over from mirror paint to tile paint, all that is required is the cleaning of the paint curtain head and reservoir that feeds the head and the temporary inactivation of chemical sections as appropriate to limit the mirror production line to the painting and curing of the paint on the panel glass. In this way, existing assets can be used to produce a new product and the production of the new product can be intermittent according to product demand.

Thus, the invention may be embodied in a method of mass producing painted glass panels or tiles, comprising: placing a sheet of a glass substrate having a front face and a rear face on a conveyor, with the front face down; conveying said sheet of glass through at least one cleaning section to prepare the glass substrate for receiving paint; conveying said sheet of glass through a drying section to dry the glass substrate; applying pigmented, direct to glass paint to the rear face of the glass substrate; transporting said painted sheet of glass through an oven to dry and cure said paint; and cutting said painted sheet of glass to define a plurality of painted glass panels or painted glass tiles.

In certain example embodiments of this invention, a glass having a visible transmission of at least 75% (more preferably at least 80%, even more preferably at least 85%, and most preferably at least about 90%) is provided as the glass substrate. Thus invention may also be embodied in a coated glass article comprising:

a glass substrate comprising, on a weight basis:

SiO₂ from about 67-75%,

Na₂O from about 10-20%,

CaO from about 5-15%,

MgO from about 0-5%,

Al₂O₃ from about 0-5%;

K₂O from about 0-5%,

BaO from about 0-1%,

and a colorant portion comprising erbium oxide and iron oxide;

wherein the glass has visible transmission of at least 75%, and at least one of a transmissive a* color value of −1.0 to +1.0 and a transmissive b* color value of −1.0 to +1.5; and a non-metallic, pigmented paint coating disposed on a rear surface of said glass substrate.

A further object of this invention is to provide a coated painted glass tile or panel that can shed water, that can reduce or minimize corrosion, and that is abrasion resistant, and/or can repel dirt and the like. Thus, in an embodiment of the invention, the glass substrate that is painted on its rear face and cut to define painted glass tiles or painted glass panels is coated with a coating that includes highly tetrahedral amorphous carbon that is a form of diamond-like carbon (DLC).

Accordingly, the invention may also be embodied in a glass panel comprising: a glass substrate having front and rear surfaces; a non-metallic, pigmented paint coating disposed on said rear surface of said glass substrate; and a coating including a layer comprising diamond-like carbon (DLC) on said front surface of said glass substrate.

In accordance with a further alternate feature of the invention, rather than standard, flat glass, patterned glass may be used to form painted glass tiles or painted glass panels embodying the invention. In accordance with this alternative, the patterned side of the glass is painted and the glass panel is cut as desired to a panel or tile size for application to a floor or wall.

Thus invention may also be embodied in a glass panel comprising: a glass substrate having front and rear surfaces; a pattern defined embossed in said rear surface of said glass substrate; and a paint coating disposed on said patterned rear surface of said glass substrate.

### BRIEF DESCRIPTION OF THE DRAWINGS

FIG. 1 is a perspective view of a mirror line, illustrating adaptation for producing painted glass panels;

FIG. 2 is a schematic cross-sectional view of a painted glass panel/tile in an example embodiment of the invention;

FIG. 3 is a schematic cross-sectional view of a painted glass panel/tile in another example embodiment of the invention;

FIG. 4 is a schematic cross-sectional view of a painted glass panel/tile in yet another example embodiment of the invention;

FIG. 5 is a schematic perspective view of glass tiles produced according to an embodiment of the invention mounted to a shower wall; and

FIG. 6 is a schematic perspective view of patterned glass panels produced according to an embodiment of the invention mounted to a shower wall.

### DETAILED DESCRIPTION OF THE INVENTION

As noted above, in an embodiment of the invention a conventional mirror line is adapted for applying opaque paint to glass in connection with the production of painted glass panels and tiles. Thus, the invention will be described with reference to an example of a conventional mirror line, highlighting the modifications to the mirror line to accommodate painted glass panel and tile production. It is to be understood that rather than adapting a mirror line as described hereinbelow, a mass production apparatus dedicated to painted glass panel and tile production may be provided. However, an advantage of using a conventional mirror line is reduced capital investment and extra capacity on the mirror line.

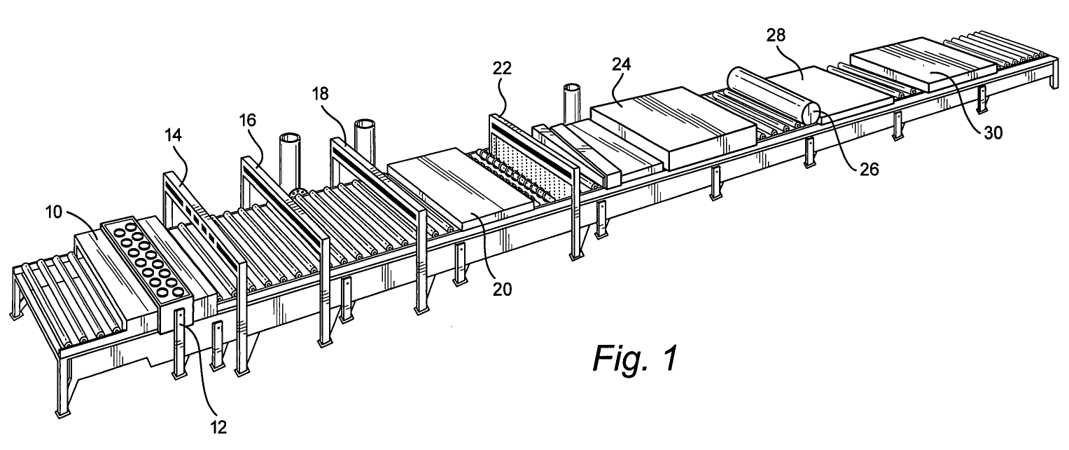

FIG. 1 illustrates an example of a conventional mirror line that may be adapted to painting glass for mass production of painted glass panels and tiles in an embodiment of the invention. The illustrated mirror line has for example a 100 inch width of loadable conveyor and is approximately 210 feet in length. In the illustrated embodiment, reference numeral 10 designates a loading conveyor and powder cleaner. Reference number 12 designates a cleaning section. Sections 14, 16 and 18 are specifically adapted to mirror production respectively defining a thinning section, a silvering section and a galvanic section. Station 20 is a drying station which would be used in connection with tile painting, as described in greater detail below. In one embodiment of the invention, painting section 22, oven section 24 and face cleaning and unloading section 30 are used, as also described hereinbelow. In an alternate embodiment, the painting section 22 is inactivated and instead a UV roller coater and oven 28 provided downstream of a forced cooling section 26 is utilized. The oven section 24 and cooling section 26 are not required for UV painting and curing.

In an embodiment of the invention, the paint curtain coater 22 that is conventionally used for mirror paint is adapted to deliver direct to glass (DTG) pigmented paint. In an exemplary embodiment, the DTG paint is applied in the same manner that the mirror coat paint is conventionally applied, as a curtain of material to a prescribed thickness on the back face of a sheet of glass. In a typical application, paint is delivered, e.g., in a 55 gallon drum and is gravity fed to a reservoir. The paint is pumped from the reservoir through a filter and then to the curtain head. The curtain head itself is set across the width of the mirror line. Paint simply falls by gravity from the curtain head through precision ground lips which run the length of the curtain head and are operator adjustable for precise application of the paint. As the glass sheet accelerates through the curtain of paint, the paint is applied to the rear surface to a specified thickness. A suitable DTG paint is available from HILEMN/SPRAYLAT. Another curtain coater may be provided to run in series with the mirror line coater to allow for a quick change over of colors and also to use for backup when the primary coater is being cleaned.

Referring to the adaptation of the mirror line to the production of painted glass panels and glass tiles, glass is placed on the conveyor at 10 and travels through a series of cleaning sections 12 in preparation for receiving paint. Where the paint curtain coater 22 is used for applying paint to the glass, the chemical sections relating to mirror production, sections 14, 16 and 18, along with UV section 28 are used only for conveyance of the product. Thus, following cleaning section(s) 12, the glass then enters drying section 20 which in an exemplary embodiment is comprised of top and bottom air knives and an oven that heats the glass. The glass is heated for two reasons. First to ensure that there is no moisture on the glass to ensure uniform deposition and curing of the paint thereon. Second is to allow solvents in the paint once applied to start flashing or evaporating before the painted glass panel enters the main curing oven 24. The flash off section includes an exhaust hood over the production line between the paint curtain 22 and the main curing oven 24 and is ducted to the outside. The glass then travels through the main oven 24 which cures the paint. From the main oven, the glass travels through cool down section 26, and then to the face down cleaner and final washer 30. The painted glass product is then inspected for shipment or further fabrication of the product, such as cutting to tiles or panels of a designated size.

As an alternative to applying paint with a curtain head, the paint can be applied using a roller that is as long as the mirror line is wide. The paint application method whether roller or paint curtain may be determined based upon the paint being applied, and whether the surface of the glass to be painted is patterned (as described hereinbelow) or flat. Roller application may be preferred for some applications, such as for patterned glass to minimize the potential for paint pooling in the patterned design.

As an alternative to applying paint using the paint curtain or a roller followed by curing by heat in the main oven 24, a UV curable paint may be applied. In such a case, the UV curable paint is applied, e.g., by means of a roller in the UV section 28 and the paint curtain portion 22 of the mirror or other assembly line is temporarily disabled or inactivated. Again, the roller is as long as the mirror line is wide and will come into direct contact with the glass. After the UV curable coating is applied, the glass continues into the UV oven processor where it is cured by ultraviolet light. In this example embodiment, a roller was selected to apply the UV curable coating because of the viscosity of the material. It is conceivable, however, that the UV curable coating could be applied by curtain coater.

The product can be run “on size” or run as a large sheet of glass that is then cut down into smaller pieces. In the latter case, the large sheet size is determined at the time of order enter to allow best optimization of the product. Once coated and ready for cutting, the product can be cut with a standard hand cutter for straight or patterned glass cuts or cut by means of automated cutting equipment for straight or patterned cuts. Once cutting has been completed, the glass can be fabricated for various edge work, beveling, grooving or the like to meet customer specifications.

The process according to the invention allows the rapid production of, e.g., 12×12 tiles, a size not typically available among imported glass tiles. Smaller tiles of course may be produced using the process of the invention. However smaller tiles will be more labor intensive and therefore are preferably reserved for decorative tile accents whereas 12×12 tiles would be used for so-called field tiles.

Typically mirror glass is produced to have a thickness of 2 mm to 6 mm (¼ inch max) depending upon the size and application. Conventional floor tiles are typically on the order of 8-10 mm ( 5/16-⅜ inch) thick. The glass processed along a modified mirror line in an embodiment of the invention to produce painted glass panels or tiles would have a thickness of about 2 mm to 14 mm consistent with the intended end use, whether it be floor, counter or wall. Consequently, as will be understood, minor adjustments may be required to the production line to accommodate the thicker glass. For example, an air knife may be adjusted up for clearance to accommodate the thicker glass panel. However, these minor adjustments are well understood to accommodate even the varying thicknesses of typical mirror glass.

Highly Transmissive and Colorless Glass Substrate

In an exemplary embodiment of the invention, the glass selected to receive paint is highly transmissive to visible light, for example 89% or more transmissive more preferably 90% are more transmissive, and also colorless so that the paint applied to the rear surface is uniformly visible and consistently colored. U.S. Pat. No. 6,610,622 (the entire disclosure of which is incorporated herein by this reference), co-pending application Ser. No. 10/785,716 (the entire disclosure of which is incorporated herein by this reference), and co-pending application Ser. No. 10/800,015 (the entire disclosure of which is incorporated herein by this reference) disclose clear glass compositions having a high visible transmission and/or fairly clear or neutral color that may advantageously be used as the glass sheets or panels that are painted in accordance with the invention.

Accordingly, in an embodiment of the invention, the glass comprises a base glass comprising:

### Example Base Glass 1

| Ingredient | Wt. % |
|---|---|
| SiO₂ | 67-75% |
| Na₂O | 10-20% |
| CaO | 5-15% |
| MgO | 0-5% |
| Al₂O₃ | 0-5% |
| K₂O | 0-5% |
| BaO | 0-1% |

Other minor ingredients, including various conventional refining aids, such as SO₃, carbon, and the like may also be included in the base glass. In certain embodiments, for example, glass herein may be made from batch raw materials silica sand, soda ash, dolomite, limestone, with the use of salt cake (SO₃) and/or Epsom salts (e.g., about a 1:1 combination of both) as refining agents. Preferably, soda-lime-silica based glasses herein include by weight from about 10-15% Na₂O and from about 6-12% CaO.

In addition to the base glass (e.g., see table above), in making glass according to certain example embodiments of the instant invention the glass batch includes a colorant portion having materials (including colorants and/or oxidizers) which cause the resulting glass to be fairly neutral in color and/or have a high visible light transmission. These materials may either be present in the raw materials (e.g., small amounts of iron), or may be added to the base glass materials in the batch. In certain example embodiments of this invention, the resulting glass has visible transmission of at least 75%, more preferably at least 80%, even more preferably of at least 85%, and most preferably of at least about 90%. In certain example non-limiting instances, such high transmissions may be achieved at a non-limiting reference thickness of about 5.6 mm, or alternatively at a non-limiting reference thickness of about 6 mm. In certain example instances, the glass has a visible transmission of at least 90.5% at such reference thicknesses.

In certain embodiments of this invention, in addition to the base glass, the glass batch comprises or consists essentially of additional materials (in terms of weight percentage of the total glass composition):

### Example Glass Batch (in Addition to Base)

| Ingredient | General | More Preferred | Most Preferred |
|---|---|---|---|
| total iron (expressed | 0.01-0.30% | 0.02-0.20% | 0.03-0.15% |
| as Fe₂O₃): % FeO | 0.001-0.10% | 0.002-0.05% | 0.004-0.015% |
| erbium oxide | 0-0.30% | 0.02-0.20% | 0.03-0.13% |
| (e.g., Er₂O₃): | | | |
| cerium oxide | 0-0.30% | 0-0.18% | 0.03-0.12% |
| (e.g., CeO₂): | | | |
| cobalt oxide | 0-0.050% | 0-0.001% | 0-0.0005% |
| (e.g. Co₃O₄): | | | |

In certain example embodiments of this invention, the colorant portion is substantially free of other colorants (other than potentially trace amounts). However, it should be appreciated that amounts of other materials (e.g., refining aids, melting aids, colorants and/or impurities) may be present in the glass in certain other embodiments of this invention without taking away from the purpose(s) and/or goal(s) of the instant invention. It is noted that the glass may be free or substantially free of cerium oxide and/or cobalt oxide in certain example embodiments of this invention. It is also possible for the glass to be free or substantially free of erbium oxide. In certain example embodiments of this invention, the glass may include no more than 2 ppm Se, more preferably no more than about 1 ppm Se; and/or may include no more than 10 ppm chromium oxide, more preferably no more than 6 ppm chromium oxide; and/or may includes no more than about 2 ppm cobalt oxide, more preferably no more than about 1 ppm cobalt oxide.

The batch is melted and the float process used to form glass (e.g., soda lime silica glass) in a known manner. The total amount of iron present in the glass batch and in the resulting glass, i.e., in the colorant portion thereof, is expressed herein in terms of Fe₂O₃ in accordance with standard practice. This, however, does not imply that all iron is actually in the form of Fe₂O₃ (see discussion above in this regard). Likewise, the amount of iron in the ferrous state (Fe⁺²) is reported herein as FeO, even though all ferrous state iron in the glass batch or glass may not be in the form of FeO. As mentioned above, iron in the ferrous state (Fe²⁺; FeO) is a blue-green colorant, while iron in the ferric state (Fe³⁺) is a yellow-green colorant; and the blue-green colorant of ferrous iron is of particular concern, since as a strong colorant it introduces significant color into the glass which can sometimes be undesirable when seeking to achieve a neutral or clear color.

It has been found that by providing the glass with a lower glass redox value (i.e., less iron in the ferrous state FeO) may help improved transmission and coloration to be achieved. In this regard, the proportion of the total iron in the ferrous state (FeO) is used to determine the redox state of the glass, and glass redox is expressed as the ratio FeO/Fe₂O₃, which is the weight percentage (%) of iron in the ferrous state (FeO) divided by the weight percentage (%) of total iron (expressed as Fe₂O₃) in the resulting glass. In certain example embodiments of this invention, glass may have a redox value (i.e., FeO/Fe₂O₃) of less than or equal to 0.25, more preferably less than or equal to 0.20; even more preferably less than or equal to 0.16, and sometimes less than or equal to 0.13.

Glass redox is defined above. However, batch redox is different from glass redox. Batch redox is known in the art as being generally based on the following. Each component of the batch is assigned a redox number, and the batch redox is calculated as the sum total of the same. The calculations are based on the amount of a component per 2,000 kg of sand. The batch redox number is calculated before the glass is made (i.e., from the batch). A detailed discussed of how “batch redox” is determined is provided in The redox number concept and its use by the glass technologist, W. Simpson and D. D. Myers (1977 or 1978), the entire disclosure of which is hereby incorporated herein by reference. In contrast, as explained above, the glass redox is calculated after the glass has been made from spectral data, and is a ratio of % FeO (e.g., from a spectrum) to total iron in the glass (e.g., from chemical analysis).

The high transmission glasses of the Comparative Examples (CEs) mentioned herein used a batch redox of slightly over 6 in the melt. In contrast, in certain example embodiments of this invention, the batch redox has been raised in value. It has surprisingly been found that higher batch redox values, when making glass of this low-iron type, have allowed resulting glasses to achieve higher visible transmission and/or more neutral color without resulting in significant glass defects. In certain example embodiments, the batch redox in the melt can be increased by altering the elements which are added to the batch in the glass making process.

In certain example embodiments of this invention, low-iron soda-lime-silica based glass is made using a batch redox of from 7.5 to 14, more preferably of from 8 to 12, even more preferably from 8.5 to 11, and sometimes from 9 to 11. As explained above, it has unexpectedly been found that such batch redox values during the glass manufacturing process have permitted glasses with higher transmittance and more neutral color to be achieved, without resulting in significant glass defects due to seediness or the like.

In certain example embodiments of this invention, the batch redox can be raised from about 6 to the aforesaid ranges by, for example and without limitation, eliminating or reducing iron sources such as rouge and/or calumite which have high ferrous content, lowering the amount of certain reducing agent(s) such as carbon, and/or increasing the amount of oxidizing and/or refining agents such as salt cake (Na₂SO₄) added to the batch. The amounts of such materials added to the batch can be adjusted until the desired batch redox is achieved.

Moreover, resulting glass according to certain example embodiments of this invention may include iron in the ferrous state (FeO) in an amount (wt. %) of from 0.001 to 0.10, more preferably from 0.002 to 0.05, and most preferably from 0.004 to 0.015%.

It is noted that glass according to certain example embodiments of this invention is often made via the known float process in which a tin bath is utilized. It will thus be appreciated by those skilled in the art that as a result of forming the glass on molten tin in certain exemplary embodiments, small amounts of tin or tin oxide may migrate into surface areas of the glass on the side that was in contact with the tin bath during manufacture (i.e., typically, float glass may have a tin oxide concentration of 0.05% or more (wt.) in the first few microns below the surface that was in contact with the tin bath).

In view of the above, glasses according to certain example embodiments of this invention achieve a neutral or substantially clear color and/or high visible transmission. In certain embodiments, resulting glasses according to certain example embodiments of this invention may be characterized by one or more of the following transmissive optical or color characteristics when measured at a thickness of from about 1 mm-6 mm (most preferably a thickness of about 5.6 mm and/or 6 mm, which are non-limiting thicknesses used for purposes of reference only) (Lta is visible transmission %):

Characteristics of Certain Example Embodiments

| Characteristic | General | More Preferred | Most Preferred |
|---|---|---|---|
| Lta (Ill. C, 2 deg.): | >=80% | >=85% | >=90% |
| L* (Ill. D65, 10 deg.): | 90-100 | n/a | n/a |
| a* (Ill. D65, 10 deg.): | −1.5 to +1.0 | −1.0 to +1.0 | −0.8 to +0.50 |
| b* (Ill. D65, 10 deg.): | −1.0 to +1.5 | −0.7 to +1.0 | 0 to +0.5 |

In certain example embodiments of this invention, a glass having a visible transmission of at least 75% (more preferably at least 80%, even more preferably at least 85%, and most preferably at least about 90%) is provided, wherein in making the glass a batch therefor includes a base glass (e.g., soda lime silica glass) and in addition comprises (or consists essentially of in certain other embodiments), by weight percentage:

| | |
|---|---|
| total iron (expressed as Fe₂O₃): | 0.01 to 0.30% |
| erbium oxide (e.g., Er₂O₃): | 0.01 to 0.30% |
| cerium oxide (e.g., CeO₂): | 0.005 to 0.30%. |

While cerium oxide is preferred in many embodiments, its presence is not a requirement.

In certain other example embodiments of this invention there is provided a glass comprising:

| Ingredient | wt. % |
|---|---|
| SiO₂ | 67-75% |
| Na₂O | 10-20% |
| CaO | 5-15% |
| total iron | 0.01 to 0.30% |
| (expressed as Fe₂O₃) | |
| erbium oxide | 0.01 to 0.30% |

wherein the glass has visible transmission of at least 75%, and at least one of a transmissive a* color value of −1.0 to +1.0 and a transmissive b* color value of −1.0 to +1.5.

Certain example embodiments of the invention fulfill one or more of the above-listed objects and/or needs by providing a method of making glass, the method comprising providing a glass batch comprising:

| Ingredient | Wt. % |
|---|---|
| SiO₂ | 67-75% |
| Na₂O | 10-20% |
| CaO | 5-15% |
| MgO | 0-5% |
| A1₂O₃ | 0-5% |
| K₂O | 0-5% |
| total iron | 0.01 to 0.30% |
| (expressed as Fe₂O₃) | |
| erbium oxide | 0.01 to 0.30% |
| cerium oxide and/or a nitrate | 0 to 2.0% |

melting the batch and forming a resulting glass that has visible transmission of at least 75%, a transmissive a* color value of −1.0 to +1.0, and a transmissive b* color value of −1.0 to +1.5.

Certain other example embodiments of this invention fulfill one or more of the above-listed objects and/or needs by providing a glass comprising:

| | |
|---|---|
| total iron | 0.01 to 0.30% |
| (expressed as Fe₂O₃) | |
| erbium oxide | 0.01 to 0.30% |
| cerium oxide | 0 to 0.30%. |

Certain other example embodiments of this invention fulfill one or more of the above-listed objects and/or needs by providing a method of making glass, the method comprising providing a glass batch comprising:

| | |
|---|---|
| total iron | 0.01 to 0.30% |
| (expressed as Fe₂O₃): | |
| erbium oxide: | 0.01 to 0.30% |
| cerium oxide and/or a nitrate: | 0 to 2.0%, and |

using the glass batch to make glass.

Certain other example embodiment of this invention fulfill one or more of the above-listed objects and/or needs by providing a glass comprising:

| | |
|---|---|
| total iron | 0.01 to 0.30%, and |
| (expressed as Fe₂O₃) | |
| erbium oxide | 0.01 to 0.30%. |

As can be seen, glasses of certain embodiments of this invention achieve desired features of fairly clear color and/or high visible transmission, while not requiring iron to be eliminated from the glass composition. This may be achieved through the provision of the unique glass redox values used in certain example embodiments of this invention and/or via the colorant portions described herein. The visible transmission of the glass may even be at least 90.5% in certain example instances.

Diamond-Like Carbon Coating

Conventional soda inclusive glasses are susceptible to environmental corrosion which occurs when sodium (Na) diffuses from or leaves the glass interior. Also, the glass tiles of the invention may be used in an environment where they will be subject to scratching or abrasives, such as on a floor or on a countertop. Accordingly, in an embodiment of the invention, the soda inclusive glass substrate that is to be painted a cut into panels or tiles in accordance with the invention, is coated with a highly tetrahedral amorphous carbon inclusive layer that is a form of diamond-like carbon (DLC). In certain embodiments, the amorphous carbon layer includes at least about 35% sp³ carbon—carbon bonds, more preferably at least about 70%, and most preferably at least about 80% sp³ carbon—carbon bonds. The high density (e.g. greater than or equal to about 2.4 gm/cm³) of the amorphous carbon layer prevents soda from exiting the glass and reacting with water at surface(s) of the glass, thereby minimizing visible stains (or corrosion) on the glass. The high density amorphous carbon layer also may repel water. In some embodiments, the highly tetrahedral amorphous carbon layer is part of a larger DLC coating, while in other embodiments the highly tetrahedral layer forms the entirety of a DLC coating on the substrate.

Thus, in accordance with an embodiment of the invention, at least the floor tiles advantageously have a diamond-like carbon (DLC) coating applied to the top surface, to provide for a scratch resistant surface that preferably also sheds or repels water.

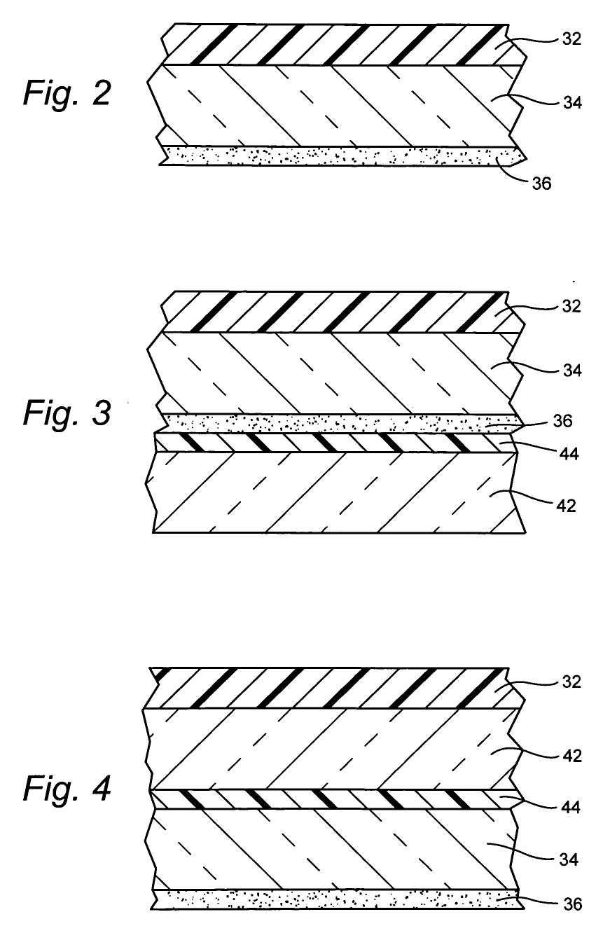

FIG. 2 is a side cross sectional view of a coated article according to an example embodiment of this invention, wherein at least one diamond-like carbon (DLC) inclusive protective coating(s) 32 is provided directly on the glass substrate 34. DLC inclusive coating 32 in the FIG. 2 embodiment includes at least one layer including highly tetrahedral amorphous carbon (ta-C). Highly tetrahedral amorphous carbon (ta-C) forms sp³ carbon-carbon bonds, and is a special form of diamond-like carbon (DLC). A high amount of sp³ bonds increases the density of a layer, thereby making it stronger and allowing it to reduce soda diffusion to the surface of the coated article. Protective layer(s) of or including DLC may be from about 1-100 nm thick in certain embodiments of this invention, more preferably from about 1-25 nm thick, even more preferably from about 1-10 nm thick, and most preferably from about 1-5 nm thick, with an example thickness of DLC inclusive layer being about 2 nm. In the illustrated embodiment, the diamond-like carbon (DLC) protective coating(s) 32 is provided directly on soda-inclusive glass substrate. At least some carbon atoms of DLC coating 32, and/or some sp² and/or sp³ carbon—carbon bonds, are provided in fissures or cracks in a surface (e.g. top surface) of the glass substrate, or may penetrate the glass surface of substrate 34 itself or the surface of growing DLC, so as to strongly bond coating 32 to substrate 34. Subimplantation of carbon atoms into the surface of substrate 34 enables coating 32 to be strongly bonded to glass substrate 34.

In certain embodiments, coating 32 may have an approximately uniform distribution of sp³ carbon-carbon bonds throughout a large portion of its thickness, so that much of the coating has approximately the same density. In other more preferred embodiments, coating 32 may include a lesser percentage of sp³ carbon-carbon bonds near the interface with substrate 34, with the percentage or ratio of sp³ carbon-carbon bonds increasing throughout the thickness of the coating toward the outermost surface. However, as noted below, in certain embodiments, there is a lesser percentage of such bonds at the outmost layer portion of coating 32 than at middle areas of the coating, so that H atoms may be provided in order to improve the coating's hydrophobic characteristics. In certain embodiments, it is desired that at least 40% of the carbon-carbon (C—C) bonds therein are of the sp³ type, more preferably at least 50% are of the sp³ type, even more preferably at least 60% are of the sp³ type (as opposed to the sp² type). In certain embodiments, it is desired to keep number of sp² carbon-carbon bonds throughout the entire thickness of the coating to no greater than about 25%, more preferably no greater than about 10%, and most preferably from about 0-5%, as these type bonds are hydrophillic in nature and attract water and the like.

The presence of sp³ carbon-carbon bonds in coating 32 increases the density and hardness of the coating, thereby enabling it to satisfactorily function for floor tile environments. In order to improve the hydrophobic nature of coating 32, atoms other than carbon (C) may be provided in the coating in different amounts in different embodiments. For example, in certain embodiments of this invention coating 32 (taking the entire coating thickness, or only a thin 1 nm thick layer portion thereof into consideration) may include in addition to the carbon atoms of the sp³ carbon-carbon bonds, silicon (Si) atoms, oxygen (O) atoms, fluorine (F) atoms, and/or hydrogen (H) atoms, for example. In certain embodiments, the outermost thin layer portion of coating 32 may also include a larger percentage of H atoms deposited via plasma ion beam treatment relative to the rest of the coating in order to reduce the number of polar bonds at the coating's surface, thereby improving the coating's hydrophobic properties by reducing the polar component of the surface energy. For example, in certain embodiments the outermost layer portion of coating 32 may include at least about 10% H atoms, more preferably at least about 25% H atoms, and most preferably at least about 50% H atoms in order to reduce surface energy. These examples are for purposes of example only, and are not intended to be limiting in any way.

In certain preferred embodiments, coating 32 has an average hardness of at least about 10 GPa, more preferably at least about 20 GPa, and most preferably from about 20-50 GPa. Such hardness renders coating 32 resistant to scratching, solvents, and the like. It is noted that the hardness and density of coating 32 may be adjusted by varying the ion energy of the depositing apparatus or process described below.

The surface of a glass substrate 34 often has tiny cracks or microcracks defined therein. These cracks may weaken glass by orders of magnitude, especially when water seeps therein and ruptures further bonds. Another advantage of certain embodiments of this invention is that amorphous carbon atoms and/or networks of DLC inclusive coating 32 fill in or collect in these small cracks because of the small size of carbon atoms. This increases the mechanical strength of the glass substrate 34.

The DLC is preferably of a type having a high density (i.e., density of at least 2.4 gm/cm³, even more preferably of at least 2.7 gm/cm³) so that it can be applied at a rather small thickness so that it does not introduce significant discoloration to the glass substrate. The DLC may also be of a type so that it can be applied using rather low temperatures of the substrate to which it is applied (e.g., temperatures lower than about 350 degrees C., more preferably lower than about 200 degrees C., and most preferably lower than about 100 degrees C.) so that the underlying layer(s) are not significantly damaged during deposition of the DLC. In certain instances, the DLC may be applied/deposited via ion beam deposition.

Moreover, in this regard, the DLC of layer may be ion beam deposited in a manner using a high ion energy (e.g., 500 to 3,000 eV per C atom) and using appropriate gas flow (e.g., a hydrocarbon gas such as acetylene) so that the resulting DLC inclusive layer can be deposited at low temperatures and has a high average density of at least about 2.4 gm/cm³, more preferably of at least about 2.7 gm/cm³ (e.g., average density of from 2.6 to 3.1 gm/cm³ in certain instances). Additionally, the ion beam deposition technique used enables the DLC (e.g., ta-C) to be characterized in that at least 40% of the carbon-carbon (C—C) bonds therein are of the sp³ type, more preferably at least 50% are of the sp³ type, even more preferably at least 60% are of the sp³ type (as opposed to the sp² type). The protective layer in certain example embodiments has an average hardness of at least about 10 GPa, more preferably of at least about 20 GPa, and most preferably of at least 30 GPa in certain embodiments of this invention.

The DLC inclusive layer, in certain example embodiments of this invention, may be any of the DLC inclusive layers described in any of U.S. Pat. Nos. 6,261,693, 6,303,225, 6,312,808, 6,338,901, or 6,783,253, all of which are hereby incorporated herein by reference. The DLC inclusive layer(s) may be ion beam deposited as described in any of U.S. Pat. Nos. 6,261,693, 6,303,225, 6,312,808, 6,338,901, or 6,783,253 (all incorporated herein by reference). In certain example instances, the DLC may be deposited using an ion beam source with acetylene gas at about 1500-3000 V potential, at a pressure such as 1 mTorr.

The use of such a high density DLC inclusive layer(s), and the ion beam deposition techniques described above, enables layer(s) to be ion beam deposited onto the glass substrate in a very dense manner. Moreover, the high density of DLC inclusive layer enables a rather thin layer of the same to provide good protective properties (e.g., scratch resistance), which small thickness of layer enables reduction and/or prevention of the occurrence of undesirable brown/yellow color so often associated with DLC coatings. Moreover, the ion beam deposition process can be adjusted to achieve an index of refraction for the layer that can be used for antireflection purposes.

Thus, in certain example embodiments of this invention, the glass tile or panel is comprises a glass substrate supporting a coating layer comprising amorphous diamond-like carbon (DLC), and wherein the layer comprising DLC has an average density of at least about 2.4 gm/cm³ and at least about 40% of carbon-carbon bonds in the layer comprising DLC are sp³ type carbon-carbon bonds, and wherein the layer comprising DLC has an average hardness of at least about 10 GPa and/or wherein the layer comprising DLC is from about 1-100 nm thick.

With a DLC coating on the top surface and paint 36 applied to the bottom surface, it is understood that the tiles will wear extremely well without degrading the paint finish and thus maintaining the aesthetically pleasing appearance of the painted glass. For wall tile applications, a DLC coating is considered optional because of the more limited wear to which wall tiles are exposed. Of course, in some applications wall tiles and also counter tiles advantageously have a DLC coating, particularly for the hydrophobic characteristics thereof noted above and to provide a particularly resistant finish to maintain a long term like-new and unmarred appearance for a desirable, high end look.

The FIG. 2 example is formed from a single sheet of glass. The invention may also be embodied, however, in laminated glass assemblies, for increased thickness, to take advantage of properties of each of the glass substrates, to take advantage of properties of such laminated assemblies, for aesthetics, or the like. Laminated glass comprises layers of glass in a sandwich type arrangement. A typical configuration is a layer of flexible polymeric material sandwiched, e.g., using a heat and pressure process, between two layers of glass. The flexible polymeric material may be Poly Vinyl Butyral (PVB) or Poly Urethane (PU), or the laminated glass can be formed as Cast in Place (CIP) laminated glass wherein resin is poured resin into the cavity between two adjacent glass sheets.

Thus, as an example, to provide a laminated painted glass panel/tile, a second glass sheet 42 is provided for lamination to the painted glass substrate. In one example embodiment, illustrated in FIG. 3, the second glass sheet 42 is laminated (using conventional lamination processes) to the rear, painted surface of glass substrate 34 with, e.g., a PVB layer 44 interposed therebetween. In an alternative, illustrated in FIG. 4, the second glass substrate 42 is laminated (in a conventional manner) to the front surface of glass substrate 34, again with, e.g., a PVB layer 44 interposed therebetween. In the examples illustrated in FIGS. 2-4, the DLC coating is provided on the top surface of the top-most substrate. However, as mentioned above, the provision of a DLC coating is optional, largely dependent on the environment in which the painted glass tile or panel is to be used.

Patterned Glass

In accordance with a further alternate feature of the invention, rather than standard, flat glass, patterned glass may be used to form painted glass tiles or painted glass panels embodying the invention. In accordance with this alternative, the patterned side of the glass is painted and the glass panel is cut as desired to a panel or tile size for application to a floor or wall. Advantageously, the pattern may be a continuous pattern and the tiles may be supplied for lay up to recreate the original pattern. For example, the pattern applied may be in the form of flowing water, a stone wall or the like. The individual tiles may be laid out to reproduce the original pattern so that the stone work pattern, flowing water or the like is revealed by the applied tile. Because the pattern is disposed and paint applied to the rear face of the tile and the exposed face is flat and smooth, an aesthetically pleasing three dimensional pattern will be revealed.

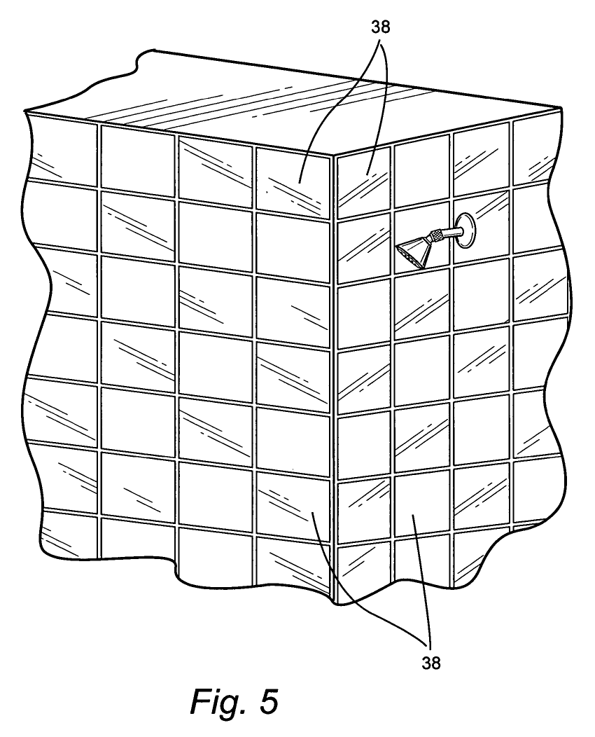

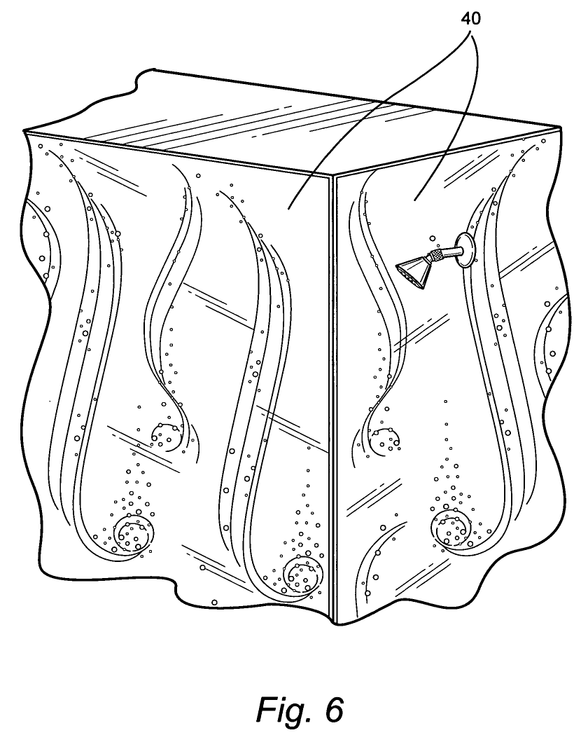

The glass tiles produced according to the invention may be applied like conventional ceramic tile using the same materials, such as a white thin set as the mastic on the tile backer board. The glass tiles may be provided as accent tiles with ceramic tiles, as wall or ceiling tile in wet areas in bathrooms and spas, for kitchen back splashes, as a countertop material and for residential flooring. The product advantageously provides a unique and upscale look with a clean, new appearance. In one embodiment, the glass tiles or panels, which may or may not be patterned glass, are provided as tub and shower surrounds. Thus, FIG. 5 depicts glass tiles 38 produced according to the invention applied like conventional ceramic or natural stone tiles as a tub or shower surround. Similarly, FIG. 6 depicts patterned glass panels 40 produced according to the invention applied as panels defining a tub or shower surround. As will be understood, patterned glass is particularly preferred for such an embodiment because of its ornamental detail without grout lines.

A temperable patterned glass sheet having a grid pattern which simulates a stacked series of glass blocks joined by mortar is disclosed in commonly owned U.S. Pat. No. 6,586,077 (the entire disclosure of which is incorporated herein by this reference), and may be selected as a patterned glass panel for being painted in the embodiment of the invention. Other patterns may be likewise applied to the glass and have conditions similar to that outlined in the '077 patent so as to be temperable. Namely, the ridges are maintained at a height less than, or the grooves to a depth less than, about 0.03 inches (0.76 mm), and preferably less than 0.016 inches (e.g. 0.0156 inches; 0.40 mm) with respect to the basic planar surface of the glass sheet, both temperablitiy and an aesthetically pleasing pattern results. In the alternative, where the glass tiles are applied with mastic to a wall or a glass panel is applied with suitable mirror mastic to a wall, the glass need not be tempered. As noted, the pattern imprinted into the sheet may be include a grid pattern so as to simulate glass blocks, bricks, or stone work, or may be an abstract or other decorative pattern.

Glass panels and tiles embodying the invention are low maintenance and they stay clean longer and require less cleaning than competitive ceramic tiles. Moreover, the product is scratch resistant so that little or no scratches appear over time for a crisp like-new look. The product is also heat resistant and exhibits minimal water absorption therefore making it an idea tile for countertops and shower enclosures.

In a bath or spa, glass tiles provide protection in wet areas, can be used as a decorative element, make cleaning easier and less frequent, and the reflective surface of the glass gives the appearance of a clean, crisp surface while exhibiting a high end and unique style. In the kitchen, the glass tiles can be used as a cutting surface for food preparation, or for receiving a hot pan. Here again the product wipes clean easier and appears cleaner than porous substances such as granite and ceramic tiles.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of mass producing painted glass panels or tiles, comprising:
placing a sheet of a glass substrate having a front face and a rear face on a conveyor, with the front face down;
conveying said sheet of glass through at least one cleaning section to prepare the glass substrate for receiving paint;
conveying said sheet of glass through a drying section to dry the glass substrate;
applying pigmented, direct to glass paint to the rear face of the glass substrate;
transporting said painted sheet of glass through an oven to dry and cure said paint; and
cutting said painted sheet of glass to define a plurality of painted glass panels or painted glass tiles

2. A method of claim 1, wherein said painting comprises painting said glass substrate using a paint curtain coater.

3. A method of claim 1, wherein said painting comprises painting said glass substrate using a paint roller.

4. A method of claim 1, wherein said painting comprises applying a UV curable paint to said glass substrate.

5. A method of claim 1, wherein said painting comprises painting said glass substrate using a non-metallic paint.

6. A method of claim 1, wherein said drying section comprises top and bottom air knives and an oven that heats the glass substrate.

7. A method of claim 1, wherein said conveyor is a conveyor of a mirror line, and wherein silver and chemical application sections associated with mirror production are inactivated mirror coat paint is replaced with said direct to glass paint.

8. A coated glass article comprising:
a glass substrate comprising, on a weight basis:
SiO₂ from about 67-75%,
Na₂O from about 10-20%,
CaO from about 5-15%,
MgO from about 0-5%,
Al₂O₃ from about 0-5%;
K₂O from about 0-5%, BaO from about 0-1%,
and a colorant portion comprising erbium oxide and iron oxide;
wherein the glass has visible transmission of at least 75%, and at least one of a transmissive a* color value of −1.0 to +1.0 and a transmissive b* color value of −1.0 to +1.5; and
a non-metallic, pigmented paint coating disposed on a rear surface of said glass substrate.

9. A coated glass article as in claim 8, wherein the colorant comprises:
total iron (expressed as Fe2O3) from about 0.01 to 0.30%
erbium oxide (e.g., Er2O3) from about 0-0.30%
cerium oxide (e.g., CeO2) from about 0-0.30% cobalt oxide (e.g. Co3O₄) from about 0-0.050%

10. A coated glass article as in claim 8, wherein the glass has visible transmission of at least 85%.

11. A coated glass article as in claim 10, wherein the glass has visible transmission of at least 90%.

12. A coated glass article as in claim 8, further comprising a coating including diamond-like carbon (DLC) and sp³ carbon-carbon bonds provided on a front surface of said glass substrate.

13. A coated glass article as in claim 8, wherein said coated glass article comprises a glass tile having a dimension of about 12 inches by 12 inches.

14. A glass panel comprising:
a glass substrate having front and rear surfaces;
a pattern defined embossed in said rear surface of said glass substrate; and
a paint coating disposed on said patterned rear surface of said glass substrate.

15. The glass panel of claim 11, wherein the pattern comprises ridges and/or grooves extending across at least a part of the rear surface

16. The glass panel of claim 12, wherein said ridges or grooves extending from the planar surface a distance less than 0.03 inches.

17. A glass panel comprising:
a glass substrate having front and rear surfaces;
a non-metallic, pigmented paint coating disposed on said rear surface of said glass substrate; and
a coating including a layer comprising diamond-like carbon (DLC) on said front surface of said glass substrate.

18. The glass panel as in claim 17, wherein said glass panel comprises a glass tile having a dimension of about 12 inches by 12 inches.

19. The painted glass panel of claim 17, wherein said coating has an average hardness of from about 20-80 GPa.

20. The glass panel as in claim 17, wherein the layer comprising DLC has an average density of at least about 2.4 gm/cm³.

21. The painted glass panel of claim 20, wherein the layer comprising DLC has an average density of at least about 2.7 gm/cm³.

22. The glass panel as in claim 17, wherein at least about 40% of carbon-carbon bonds in the layer comprising DLC are sp³ type carbon-carbon bonds, and wherein the layer comprising DLC is from about 1-100 nm thick.

23. The painted glass panel of claim 22, wherein said DLC coating has a thickness of from about 1-50 nm.

24. The painted glass panel of claim 17, wherein the layer comprising DLC is hydrogenated.

25. The painted glass panel of claim 24, wherein the layer comprising DLC comprises from 0.5 to 20% hydrogen.

26. The painted glass panel of claim 17, wherein layer comprising diamond-like carbon (DLC) is provided on and in direct contact with said glass substrate.

27. The painted glass panel of claim 17, wherein said DLC coating includes at least a first highly tetrahedral amorphous carbon layer having at least about 35% sp³ carbon—carbon bonds and an average density of at least about 2.4 gm/cm³.

28. The painted glass panel of claim 27, wherein sp³ carbon—carbon bonds are subimplanted into said glass substrate so as to bond said DLC coating to said glass substrate.

29. The painted glass panel of claim 27, wherein said highly tetrahedral amorphous carbon layer has more sp³ carbon—carbon bonds than sp² carbon—carbon bonds.

30. The painted glass panel of claim 17, wherein said diamond-like carbon (DLC) inclusive layer is deposited directly on a surface of said glass substrate in a manner so that the diamond-like carbon (DLC) inclusive layer includes more sp³ carbon—carbon bonds than sp² carbon—carbon bonds; and
wherein sp³ carbon—carbon bonds are subimplanted into said glass substrate so as to bond said DLC inclusive layer to said glass substrate.

31. A glass panel comprising:
a first glass substrate having front and rear surfaces;
a non-metallic, pigmented paint coating disposed on said rear surface of said glass substrate; and
a second glass substrate having front and rear surfaces, said second glass substrate being laminated to one of 1) said front surface of said first glass substrate and 2) said paint coated rear surface of said glass substrate.

32. A laminated, painted glass panel of claim 31, further comprising a coating including a layer comprising diamond-like carbon (DLC) on the front surface of one of said first and second glass substrates.

33. A laminated, painted glass panel of claim 31, wherein at least one of said first and second glass substrates comprises, on a weight basis:
SiO₂ from about 67-75%,
Na₂O from about 10-20%,
CaO from about 5-15%,
MgO from about 0-5%,
Al₂O₃ from about 0-5%;
K₂O from about 0-5%,
BaO from about 0-1%,
and a colorant portion comprising erbium oxide and iron oxide;
wherein the glass has visible transmission of at least 75%, and at least one of a transmissive a* color value of −1.0 to +1.0 and a transmissive b* color value of −1.0 to +1.5
